(19) United States
(12) Patent Application Publication
(10) Pub. No.: US 2003/0213351 A1
(43) Pub. Date: Nov. 20, 2003

(54) Slide cam die

(76) Inventor: Mitsuo Matsuoka, (US)

Correspondence Address: BIRCH STEWART KOLASCH & BIRCH, PO BOX 747, FALLS CHURCH, VA, 22040-0747, US

(21) Appl. No.: 10/409,474

(22) Filed: Apr. 9, 2003

(30) Foreign Application Priority Data
May 16, 2002 (JP) 2002-141639

(51) Int. Cl. B26D 5/08

(52) U.S. Cl. 83/588; 83/620

(57) ABSTRACT

It is an object that when a pierce punch, a flange block or the like are necessary to be demounted for reasons such as adjustment, the pierce punch, the flange block or the like is singly demounted without taking out a slide cam as a whole to thereby reduce a working time, in addition, only an adapter plate is replaced to thereby enable the reuse of a slide cam and attain cost reduction, furthermore, a given slide cam is used to increase flexibility in design aspect to a great degree.

A slide cam die including; a slide cam base; a wedge-shaped slide cam sliding on a guide surface of the slide cam base and mounting a press tool such as a punch or a trimming blade thereon; and an actuating cam driving the slide cam in contact therewith, wherein a press tool is mounted on the slide cam with an adapter plate interposing therebetween.

### BACKGROUND OF THE INVENTION

The present invention relates to a slide cam die for fabricating a metal thin plate with a press machine.

In a slide cam die including; a slide cam base; a wedge-shaped slide cam sliding on a guide surface of the slide cam base and mounting a press tool such as a punch or a trimming blade thereon; and an actuating cam driving the slide cam in contact therewith, a pierce punch, a flange block or the like mounted on the slide cam could not be singly demounted therefrom when a need therefore arose for reasons such as adjustment but the slide cam mounting the pierce punch, the flange block or the like had to be taken out as a whole.

There has been a desire that when a pierce punch, a flange block or the like are necessary to be demounted for reasons such as adjustment, the pierce punch, the flange block or the like is singly demounted with taking out the slide cam as a whole to thereby reduce a working time, in addition, only an adapter plate is replaced to thereby enable the reuse of a slide cam and attain cost reduction, furthermore, a given slide cam is sued to increase flexibility in design aspect to a great degree.

Accordingly, in light of the above circumstances, the present invention has achieved the following tasks that when a pierce punch, a flange block or the like are necessary to be demounted for reasons such as adjustment, the pierce punch, the flange block or the like is singly demounted without taking out a slide cam as a whole to thereby reduce a working time, in addition, only an adapter plate is replaced to thereby enable the reuse of a slide cam and attain cost reduction, furthermore, a given slide cam is used to increase flexibility in design aspect to a great degree; and a slide cam die including; a slide cam base; a wedge-shaped slide cam sliding on a guide surface of the slide cam base and mounting a press tool such as a punch or a trimming blade thereon; and an actuating cam driving the slide cam in contact therewith, wherein a press tool is mounted on the slide cam with an adapter plate interposing therebetween.

Moreover, the present invention, to be concrete, has a feature that a lock plate is mounted on the slide cam to engage with an end portion of the adapter plate to position the adapter plate correctly.

Furthermore, the present invention, to be concrete, has a feature that the adapter plate is formed so as to have a section of an L letter shape and positioned by putting an inner face thereof into contact with the slide cam.

Still furthermore, the present invention, to be concrete, has a feature that the slide cam is a lower die.

Yet furthermore, the present invention, to be concrete, has a feature that the slide cam is an upper die.

### BRIEF DESCRIPTION OF THE DRAWINGS

FIG. 1 is a longitudinal sectional view at the lower dead point of a slide cam die of the present invention.

FIG. 2 is a view taken in the direction of arrows from line II-II of FIG. 1;

FIG. 3 is a plan view of an adapter plate of the present invention;

FIG. 4 is a side view of the adapter plate of the present invention;

FIG. 5. is a front view of the adapter plate of the present invention;

FIG. 6 is a bottom view of a lock plate of the present invention;

FIG. 7 is a side view of the lock plate of the present invention;

FIG. 8 is a front view of the lock plate of the present invention; and

FIG. 9 is a longitudinal sectional view at the upper dead point of the slide cam die of the present invention.

### DESCRIPTION OF THE PREFERRED EMBODIMENTS

Hereinafter, the present invention will be explained in detail on the basis of a concrete embodiment shown in the accompanying drawings.

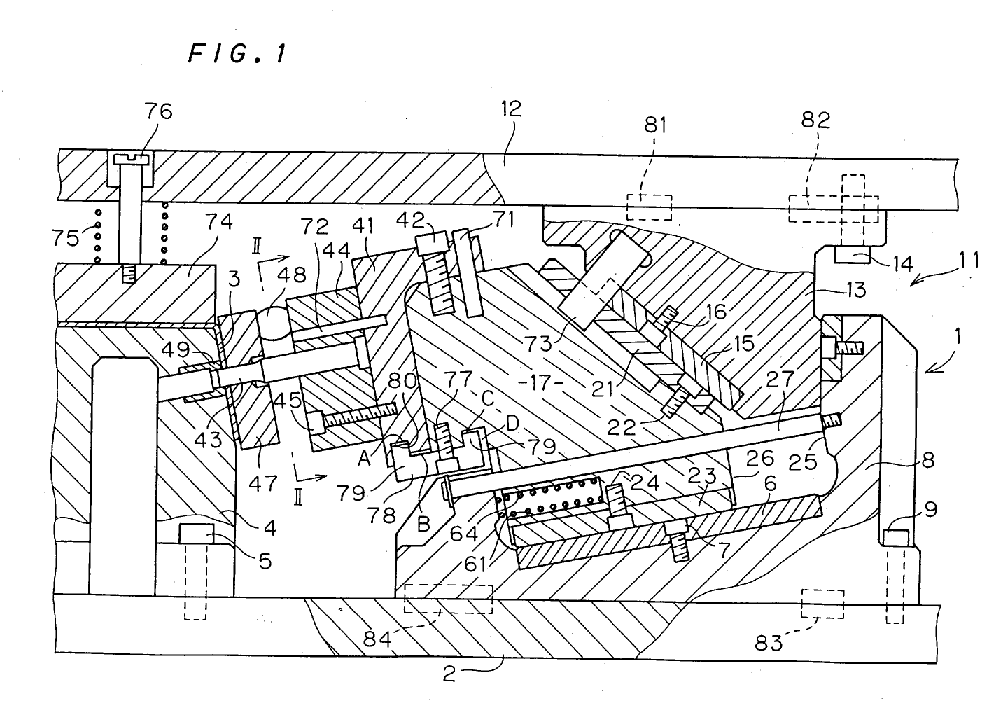

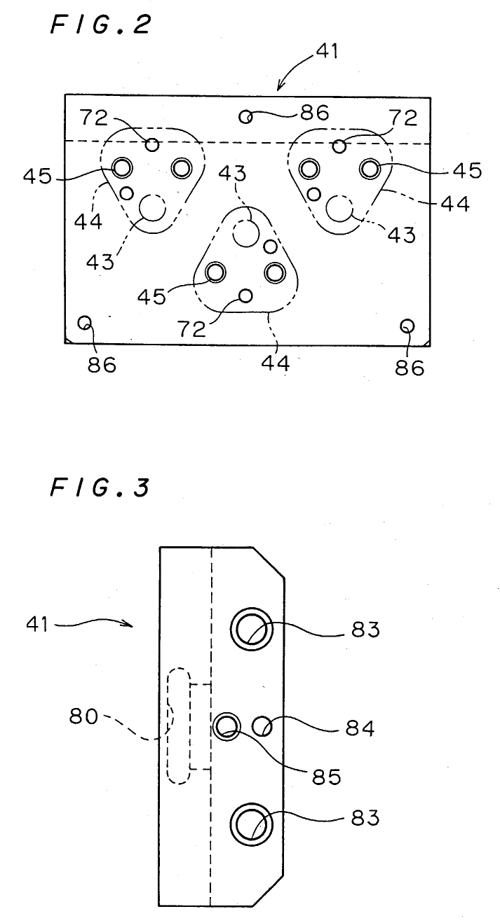

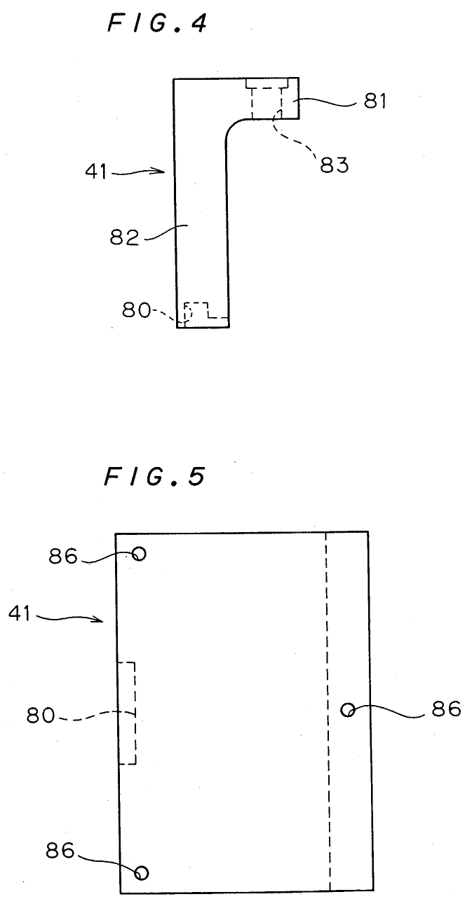

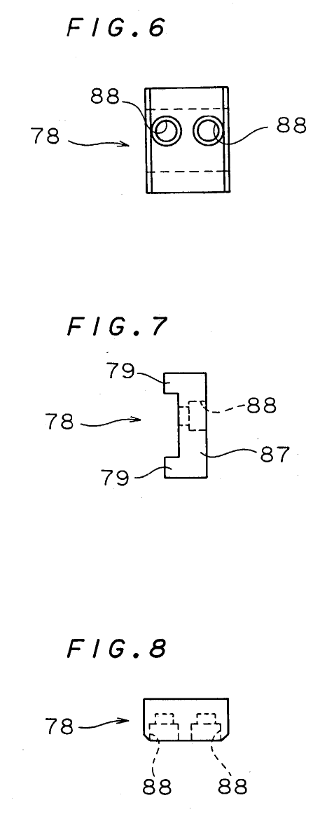

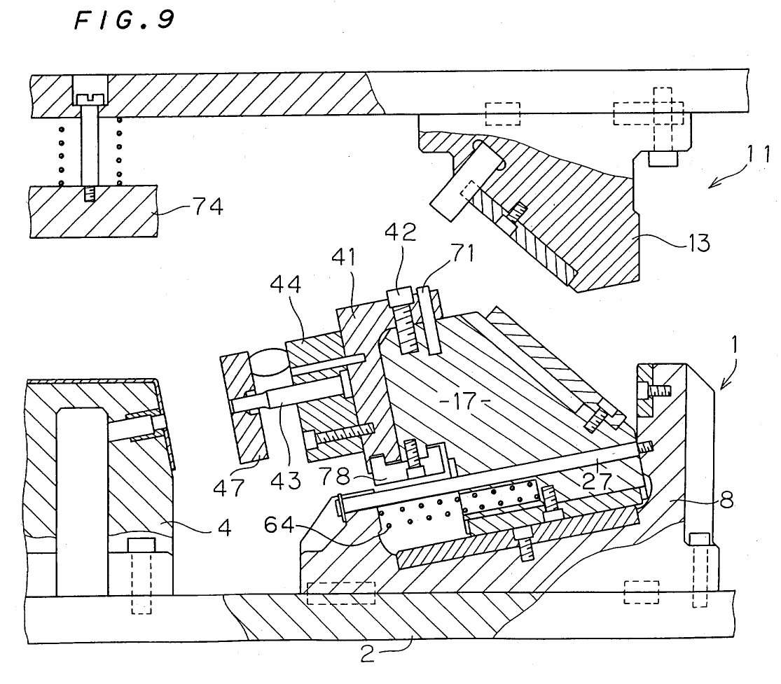

FIG. 1 is a longitudinal sectional view at the lower dead point of the slide cam die, FIG. 2 is a view taken in the direction of arrows from line II-II of FIG. 1, FIG. 3 is a plan view of an adapter plate, FIG. 4 is a side view of the adapter plate FIG. 5 is a front view of the adapter plate, FIG. 6 is a bottom view of a lock plate, FIG. 7 is a side view of the lock plate, FIG. 8 is a front view of the lock plate and FIG. 9 is a longitudinal sectional view at the upper dead point of the slide cam die.

An example described in the present embodiment is described about an example to make a hole in a work.

A positioning member 4 to position a work 3 is fixed on a base plate 2 of a lower die 1 with a bolt 5. In the neighborhood of the positioning member 4, a slide cam base 8 mounting a wear plate 6 having an upper face inclining downwardly toward the positioning member 4 with bolt 7 is fixed to the base plate 2 with a bolt 9.

An actuating cam 13 is fixed to a base plate 12 of an upper die 11, facing the slide cam base 8, with a bolt 14. At the distal end of the actuating cam 13, a wear plate 15 is fixed with bolt 16 on a face inclining upwardly toward the positioning member 4, symmetrically with an inclined face of the slide cam base 8.

A slide cam 17 in the shape of a wedge is provided, which freely slides on the wear plate 15 of the actuating cam 13 and slides on the wear plate 6 of the slide cam base 8.

The slide cam 17 is the shape of a wedge, a wear plate 21 is fixed to an upper inclined face thereof with a bolt 22, a wear plate 23 is fixed to a lower inclined face thereof with a bolt 24, and the wear plates 21 and 23 slide, respectively, on the wear plate 15 of the actuating cam 13 and on the wear plate 6 of the slide cam base 8 in contact with them.

On the work processing side at the upper front end formed on the square of the slide cam 17, an adapter plate 41 is mounted thereto with a bolt 42 and positioned with a knock pin 71, and protruding pieces 79 of a lock plate 78 fixedly attached to the slide cam 17 below the upper front end thereof with bolts 77 are engaged in a positioning groove 80 at the lower part of the adapter plate 41. A pierce punch 43 is erected in a punch retainer 44 and the punch retainer 44 is screwed on the adapter plate 41 with a bolt 45 and positioned with a knock pin 72.

A stripper plate 47 is pressed by a cushion rubber 48 to press the work 3 prior to make a hole in the work 3.

A reference numeral 49 indicates a die for carrying out a hole making by fittingly mating with the pierce punch 43.

In order to retreat the slide cam 17 after making a hole, a retaining hole 61 is formed in the lower front part of the slide cam 17 and an elastic member such as a coil spring 64 or the like is provided in a contracted form between the retaining hole 64 and the slide cam base 8. When the upper die 11 rises, the slide cam 17 is retreated by a press force of the coil spring 64. In order to stop the retreat of the slide cam, an erected stopper surface 25 is formed on the slide cam base 8 so as to be put into contact with a rear end face 26 of the slide cam 17. Noted that a guide rode 27 attached to the slide cam base 8 penetrating the slide cam 17 therethrough guides movement of the slide cam 17.

Furthermore, when the upper die rises, a return plate 73 is fixedly mounted into the actuating cam 13 and the lower end thereof is engaged with the slide cam 17 in order to forcibly retreat the slide cam 17.

In the upper die 11, a pad 74 is suspended from the base plate 12 with a suspension bolt 76 under a press by a coil spring 75.

Noted that reference numerals 81 and 82 indicate positioning keys for the actuating cam, and reference numerals 83 and 84 indicate positioning keys for the slide cam base 8.

Then, actuation of the metal die will be described.

A state shown in FIG. 9 is the upper dead point thereof.

The work 3, as shown in FIG. 9, is placed on the positioning member 4 and the upper die 11 is moved down.

When the upper die 11 fails from the state, the pad 74 presses the work 3, the wear plate 21 of the slide cam 17 is put into contact with the ware plate 15 of the actuating cam 13 and the slide cam 17 advances toward the work 3 in a space interposed between the slide cam base 8 and the actuating cam 13 with more of a fall of the upper die 11 to make a hole in the work 3 with the pierce punch 43.

FIG. 1 shows that a state where a hole has been made by the pierce punch 43 and the upper die 11 is positioned at the lower dead point.

Thereafter, when the upper die rises, a press force of the coil spring 64 is transmitted to the slide cam 17 to cause it to retreat and a rear end face 26 of the slide cam 17 comes into contact with the stopper face 25 to cease its movements there.

Since the return plate 73 is provided to the slide cam 17, the return plate 73, when the slide cam 17 does note retreat for some reason or other, causes forcibly the slide cam 17 to retreat by engaging with the slide cam base 8.

The adapter plate 41 and the lock plate 78 will be description will be descrived.

The adapter plate, as shown in FIGS. 3 to 5, is constituted of engaging piece 81 and a hanging-down piece 82 to be in the shape of an L letter as a whole and the inner face thereof is formed so as to facilitate positioning thereof by putting it into contact with the right angle corner at the upper front end of the slide cam 17. In the engaging piece 81, there are formed two bolt holes 83, one knock pin hole 84 and one bolt hole 85. The bolt hole 85 facilitates demounting the adapter plate 41 by screwing a bolt thereinto to thereafter, pull up if the adapter plate 41 is hard to be demounted.

In order to correctly position it in the front-rear direction, the positioning groove 80 in the shape of an L letter is formed at the lower end of the dropping piece 82.

Furthermore, three reference holes 86 for correctly mounting the pierce punch 43 or the like is formed on a mounting surface for the punch retainers 44 of the adapter plate 41.

Though the adapter plate 41 is of a sectional shape of an L letter, it can be one piece type or a split type.

On the lock plate 78, as shown in FIGS. 6 to 8, the protruding pieces 79 are protruded from both sides of a base piece 87 and two bolt holes 88 are formed in the base piece 87.

In case of taking out the pierce punch 43 due to a chipping-off of blade edge thereof or the like, as shown in FIG. 9, if a sufficient working space exists above the adapter plate 41 while the upper die II is at the position of the upper dead point, the bolt 42 is removed, and the knock pint 71 is pulled off, the adapter plate 41 can be moved upwardly to demount, besides, the pierce punch or the like tool is installed to the adapter plate 41; therefore, demounting of the pierce punch 43 is easily enabled without taking off the slide cam 17 as a whole.

For mounting the pierce punch 43, the inner face in the shape of an L letter of the adapter plate 41 attached to the pierce punch 43 is put into contact with the upper front end face of the slide cam 17, in addition, the protruding pieces 79 of the lock plates 78 is engaged with the adapter plate 41.

With the engagement between the adapter plate 41 and the protruding pieces 79 of the lock plate 78, positioning of the adapter plate 41 in the front to rear direction can be correctly performed. In addition, no need arises for pullingout/inserting of a knock pin for the lock plate 78 and the adapter plate 41 is simply moved from above to below while sliding to engage the positioning groove 80 with the protruding pieces 79. As shown in FIG. 1, in order to correctly position the positioning groove 80 and the protruding pieces 79 therebetween in the front to rear direction, there are intentionally provided clearances A, B, C and D between the ceiling of the positioning groove 80, the upper surfaces of the protruding pieces 79 and the like. As declared in the figures, contact faces at three sites are formed among the lock plate 78, the adapter plate 41 and the slide cam 17 in the front to rear direction and contact faces, and only one site is formed in the above to below direction.

In the above mentioned embodiment, while the example in which a corner angle of the section in the shape of an L letter of the adapter plate 41 is an right angle is described, the present invention has no specific limitation thereto, but can set to optional angle. A preferable example is a case where an angle of the corner of the section in the shape of an L letter is a right angle.

In the embodiment described above, while the example in which the actuating cam 13, the slide cam 17 and the slide cam base 8 are arranged sequentially in the order from above to below is described, an arrangement can be adopted in the reverse order, that is, in the order of the slide cam 8, the slide cam 17 and the actuating cam 13 from above to below. In this case, adapter plates may be attached to both sides of the slide cam.

Furthermore, while the embodiment describes the example of hole making, needless to say that the present invention can be applied to other processes such as bending process.

If the actuating cam 13, the slide cam 17 and the slide cam base 8 are standardized in sizes, immediate adaptation is enabled to processing of any works with various magnitude in sizes.

The present invention is a slide cam die comprising; a slide cam base; a wedge-shaped slide cam sliding on a guide surface of the slide cam base and mounting a press tool such as a punch or a trimming blade thereon; and an actuating cam driving the slide cam in contact therewith, wherein a press tool is mounted on the slide cam with an adapter plate interposing therebetween, therefore, when a pierce punch, a flange block or the like are necessary to be demounted for reasons such as adjustment, the pierce punch, the flange block or the like is slightly demounted without taking out a slide cam as a whole to thereby reduce a working time, in addition, only an adapter plate is replaced to thereby enable the reuse of a slide cam and attain cost reduction, furthermore, a given slide cam is used to increase flexibility in design aspect to a great degree.

Moreover, the present invention, to be concrete, has a feature that a lock plate is mounted on the slide cam to engage with an end of the adapter plate to position the adapter plate correctly.

Furthermore, the present invention, to be concrete, has a feature that the adapter plate is formed so as to have a section of an L letter shape and positioned by putting an inner face thereof into contact with the slide cam.

Still furthermore, the present invention, to be concrete, has a feature that the slide cam is a lower die.

Yet furthermore, the present invention, to be concrete, has a feature that the slide cam is an upper die.

What is claimed:

1. A slide cam die comprising; a slide cam base; a wedge-shaped slide cam sliding on a guide surface of the slide cam base and mounting a press tool such as a punch or a trimming blade thereon; and an actuating cam driving the slide cam in contact therewith, wherein a press tool is mounted on the slide cam with an adapter plate interposing therebetween.

2. The slide cam die according to claim 1, wherein a lock plate is mounted on the slide cam to engage with an end of the adapter plate to position the adapter plate correctly.

3. The slide cam die according to claim 1 or 2, wherein the adapter plate is formed so as to have a section of an L letter shape and positioned by putting an inner face thereof into contact with the slide cam.

4. The slide cam die according to any of claims 1 to 3, wherein said slide cam is a lower die.

5. The slide cam die according to any of claims 1 to 3, wherein said slide cam is an upper die.
